(19) United States
(12) Patent Application Publication
(10) Pub. No.: US 2009/0158340 A1
(43) Pub. Date: Jun. 18, 2009

(54) INDICATING PROGRAM POPULARITY

(75) Inventors: Laxmi Patel, Irving, TX (US); Senthil K. Raghavan, Irving, TX (US); Enrique Ruiz-Velasco, Flower Mound, TX (US); Japan A. Mehta, Irving, TX (US)

Correspondence Address: VERIZON;PATENT MANAGEMENT GROUP, 1320 North Court House Road, 9th Floor, ARLINGTON, VA, 22201-2909, US

(73) Assignee: Verizon Data Services Inc., Temple Terrace, FL (US)

(21) Appl. No.: 11/956,818

(22) Filed: Dec. 14, 2007

(51) Int. Cl. G06F 13/10

(52) U.S. Cl. 725/46

(57) ABSTRACT

Data is transmitted from content processing devices to a server, the data relating to a number of times that each of one or more media programs have been accessed within a given time period. The data is aggregated to obtain an aggregate number of times that each of the one or more media programs has been accessed within the given time period. An indication of popularity for each of the one or more media programs may be determined from the data.

### BACKGROUND INFORMATION

It is generally difficult for a media consumer to identify popular or “hot” programming, particularly given the large quantity of programming commonly available. It is inconvenient and uncommon for consumers to consult conventional sources for ratings and popularity information, such as published viewer ratings. Moreover, data from conventional sources is often out-of-date. Further, conventional ratings information is generally sampled, not aggregated, and thus may tend to be unreliable. For many programs, ratings information may be unavailable. In sum, for many reasons, a consumer of media programming is unlikely to find useful ratings and popularity information when viewing program listings. Even if the media consumer does find such information, it may be out-of-date or inaccurate.

### BRIEF DESCRIPTION OF THE DRAWINGS

FIG. 1 illustrates an exemplary system for delivering an interactive program guide including ratings data.

FIG. 2A illustrates an exemplary interface including a popularity indication of ratings data for a media program within an interactive program guide graphical user interface.

FIG. 2B illustrates an exemplary interface including a popularity indication of ratings data appearing within a widget data interface.

FIG. 2C illustrates an exemplary interface including a main menu within an interactive program guide graphical user interface.

FIG. 2D illustrates an exemplary interface for display of ratings data for media programs available at a specified current time.

FIG. 2E illustrates an exemplary interface for display of ratings data for media programs that will be available at a future time.

FIG. 2F illustrates an exemplary interface for display of ratings data for on-demand media programs.

FIG. 3A illustrates an exemplary process for making ratings data available for end user access.

FIG. 3B illustrates an exemplary process for making real time or near real time ratings data available for end user access.

FIG. 4 illustrates an exemplary process for providing and accessing ratings data.

### DETAILED DESCRIPTION OF PREFERRED EMBODIMENTS

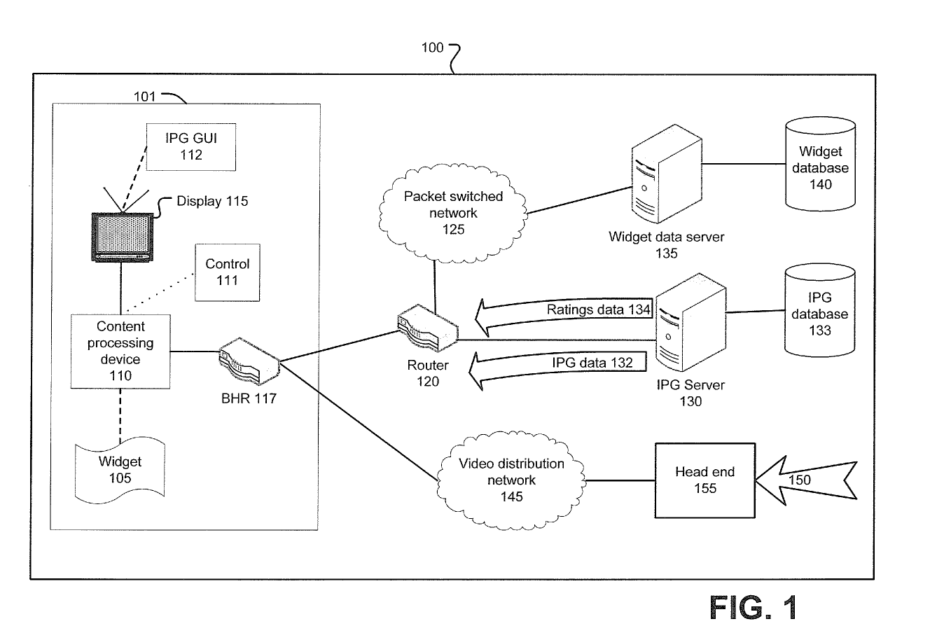

FIG. 1 illustrates an exemplary system 100 for delivering an interactive program guide including ratings data 134.

As illustrated in FIG. 1, a customer premises 101 includes a content processing device 110, which may be controlled by a user through a control 111, to view video on a video display 115. Content processing device 110 may be a set top box (STB) or similar device known for receiving a media signal, e.g., a video signal, from a network and for providing media programming, e.g., audio, video, games, etc. to a device such as video display 115.

Widget 105 includes computer-executable instructions that are generally stored in a memory of content processing device 110, and that may be executed by a processor included within content processing device 110. Instructions in widget 105 may include instructions for retrieving data from a widget data server 135, sometimes according to input provided by a user through control 111.

Control 111 is generally a remote control that selectively communicates with content processing device 110 through known wired or wireless communications, such as infrared (IR) communications. Control 111 generally includes numeric keys for selecting channels of video programming, as well as other keys for making selections and request according to menus provided on video display 115, in addition to arrow keys and the like for changing channels, changing volume, etc. Video display 115 may be a television receiver such as is known, including a conventional television or a high definition television (HDTV).

Content processing device 110 selectively communicates, via a broadband home router (B HR) 117, with a gateway router 120 to send information to, and receive information from, a packet switched network 125. An interactive program guide (IPG) server 130 also selectively communicates with router 120, sometimes via network 125, although this is not the case for the exemplary system illustrated in FIG. 1.

A widget data server 135 is also in selective communication with content processing device 110, generally via network 125. A widget database 140 may be included within widget data server 135, or may be part of a separate computing system. In any event, widget data server 135 is generally configured to selectively retrieve information from widget database 140 in response to requests for data to be included in the display of a widget 105 in display 115.

A video distribution network 145 is a network for providing a video signal 150 such as is known. For example, network 145 may include hardware and software for providing video signal 150 via coaxial cable and/or fiber optic cable. As is known, video signal 150 is generally provided to a video distribution network 145 from a head end 155.

One or more video hub offices (not pictured), sometimes referred to as “VHOs”, may serve as a point of aggregation and distribution for media content. For example, a video signal 150, e.g., a video signal encoded as a Motion Picture Experts Group-2 (MPEG 2) stream, may be provided from a head end 155 through a media distribution network 145 to a video hub office.

Packet switched network 125 is generally an internet protocol (IP) network. As such, network 125 uses known protocols for transporting data, such as user datagram protocol (UDP), transport control protocol (TCP), hypertext transfer protocol (HTTP), etc. Further, network 125 may include a variety of networks such as a wide area network (WAN), e.g., the Internet, a local area network (LAN), etc. As is known, packet switched network 125, may be used to transport a variety of data, including multimedia data such as audio and video. Accordingly, it is to be understood that networks 125 and 145 may in fact be combined into a single network, or that video distribution network 145 may simply be omitted, whereby packet switched network 125 is used to provide video signal 150 to content processing device 110, possibly through a video hub office as discussed above.

BHR 117 is known for distributing audio, video, and data to devices within customer premises 101, such as content processing device 110. For example, in one embodiment, BHR 117 is the broadband home router or wireless broadband home router from Actiontec Electronics, Inc. of Sunnyvale, Calif.

Gateway router 120 is known for routing data packets in packet switched network 125. Gateway router 120 allows content processing device 110 to access packet switched network 125. By communicating with router 120, content processing device 110 is able to obtain a network address such as an internet protocol (IP) address, thereby enabling content processing device 110 to make requests to, and to receive data from, servers 130 and 135.

IPG server 130 provides interactive program guide data (IPG data) 132 to content processing device 110 for display on display 115 as an interactive program guide graphical user interface (IPG GUI) 112. An IPG GUI 112 allows viewers of display 115 to obtain information and to select content, generally by navigating and making selections using control device 111. IPG server 130 generally includes a processor and a memory, as well as a computer readable medium such as a disk or the like for storing data, e.g., IPG data 132, to be provided to content processing device 110. An IPG database 133 may be included within IPG server 130, or may be part of a separate computing system. In any event, IPG server 130 is generally configured to selectively retrieve information from IPG database 133 in response to requests for IPG data 132. Additionally, IPG server 130 is configured to selectively retrieve ratings data 134 to be included along with a response for IPG data 132, or to be retrieved separately from IPG data 132. IPG server 130 is further configured to selectively retrieve information from content processing device 110 in order to periodically compile the ratings data 134.

Ratings data 134 includes information indicating popularity of selected media programs, media programs generally being selected for inclusion in ratings data 134 according to their popularity, e.g., the most popular media programs being selected. Ratings data 134 may be compiled, for example, using an overall aggregation of a number of times a media program has been viewed or accessed within a given time period. For example, current media accessing activity from users in a selected set of content processing devices 110, e.g., in a geographic area, having a network address within a range of network addresses, falling into certain demographic categories, randomly selected, etc. may be used to compile ratings data 134.

Ratings data 134 may be normalized to account for a different number of times that various media programs may have been broadcast or were otherwise available for access. Further, in addition to ranking a media program with respect to a global set of available media programs, ratings data 134 may also include a rating or ratings for a media program within one or more subsets of available programming. For example, ratings data 134 may be based on a type of programming, such as movie, series, sports etc.; a genre within a type, such as comedy, action, etc.; an intended audience, such as men, women, a particular age group, etc.; a geographical area, such as a time zone, a city, etc.; guide information attributes such as actor popularity, time from program release, time slot such as prime time, etc., or some other type of categorization. Additionally, ratings data 134 may include information indicating whether the popularity of a program increased or decreased from a previous reporting period. Moreover, ratings data 134 may include other information, e.g., indications of media programs most often recorded by other consumers, or most popularly played video games, etc.

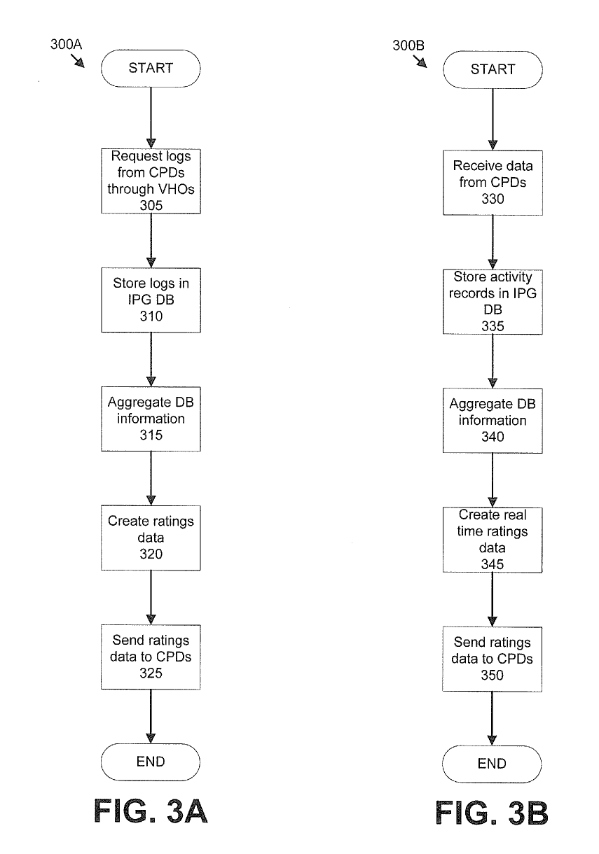

Ratings data 134 may alternately be compiled from data collected in real time or near real time. For example, various activities, including viewing or accessing a media program, may be monitored on a real time or near real time basis, aggregated, and included in ratings data 134. Real time or near real time data collection and aggregation is discussed in more detail below with reference to FIG. 3B.

Ratings data 134 may include multiple records, each record pertaining to one of a plurality of media programs. For example, ratings data 134 may include identifiers of media programs associated with a number of accesses, views, recordings, etc., as represented below in Table 1.

TABLE 1

| Media program | Accesses |
|---|---|
| Show 1 | 120,000 |
| Show 2 | 80,000 |
| Show 3 | 75,000 |
| Show 4 | 72,000 |

Ratings data 134 may further include information in addition to that shown in Table 1. For example, ratings data 134 may include the number of airings of a media program, or the number of accesses or views, adjusted to account for the number of airings, as represented below in Table 2,

TABLE 2

| Media Program | Views | Airings | Views/Airing |
|---|---|---|---|
| Show 1 | 120,000 | 2 | 60,000 |
| Show 2 | 80,000 | 1 | 80,000 |
| Show 3 | 75,000 | 1 | 75,000 |
| Show 4 | 72,000 | 2 | 36,000 |

Ratings data 134 for media programs may be weighted based on various factors, including the amount of time for which a media program has been available, when accesses of the media program have taken place, etc. Weighting ratings data 134 may be accomplished, for example, by adjusting the number of views or accesses by a factor or factors representing desired weight(s). As an example, weighting may allow a media program released two weeks in the past having 80,000 accesses to be given a lower ranking or rating in ratings data 134 than a media program released a week in the past having 70,000 accesses. Accordingly, weighting ratings data 134 may better reflect the relative popularity of various media programs than would a simple calculation based on a number of views alone, or a combination of views and number of airings, etc.

Also, ratings data 134 may include one or more categories of media programming. For example, ratings data 134 may include a categorization of media programs by genre of the media program, as represented below in Table 3.

TABLE 3

| Media program | Genre | Views/Airing |
|---|---|---|
| Show 1 | Action | 120,000 |
| Show 2 | Action | 80,000 |
| Show 3 | Comedy | 90,000 |
| Show 4 | Comedy | 60,000 |

As another example, ratings data 134 may include both genre and maturity level categories, as represented below in Table 4.

TABLE 4

| Media program | Genre | Rating | Views/Airing |
|---|---|---|---|
| Show 1 | Action | PG13 | 120,000 |
| Show 2 | Action | R | 80,000 |
| Show 3 | Comedy | PG13 | 90,000 |
| Show 4 | Comedy | G | 60,000 |

Moreover, ratings data 134 may include information indicating whether the popularity of a program increased or decreased from a previous reporting period, as represented below in Table 5.

TABLE 5

| Media program | Category | Change | Views/Airing |
|---|---|---|---|
| Show 1 | Action | Increased | 120,000 |
| Show 2 | Action | Decreased | 80,000 |
| Show 3 | Comedy | Decreased | 90,000 |
| Show 4 | Comedy | Increased | 60,000 |

Yet further, ratings data 134 may include identifiers of video games along with the number of accesses or views, as represented below in Table 6,

TABLE 6

| Media program | Views |
|---|---|
| Game 1 | 34,000 |
| Game 2 | 32,000 |
| Game 3 | 17,000 |
| Game 4 | 9,000 |

Widget data server 135 is a computing device including a processor and a memory, as well as a computer readable medium for storing data. As mentioned above, widget data server 135 selectively communicates with widget database 140 to obtain data to be displayed in widget 105 upon the request received from content processing device 110. Widget database 140 may be included on a computer readable medium within widget data server 135, or may be a separate database.

Computing devices such as content processing device 110, IPG server 130, widget data server 135, etc. may employ any of a number of computer operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

Content processing device 110 generally is a specialized device for receiving video signals 150 from head end 155 via network 145, e.g., via a VHO, and may be provided with a proprietary or specialized operating system other than those enumerated above. For example, in one embodiment, content processing device 110 is an STB provided with a real time operating system (RTOS) such as is known. However, it is to be understood that content processing device 110 may be a computing device such as one of those enumerated above, so long as the computing device is capable of receiving video signals 150 from network 145, and also is capable of storing an executing the instructions included in widget 105.

Computing devices such as content processing device 110, IPG server 130, widget data server 135, etc. generally each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Databases or data stores described herein may include various kinds of mechanisms for storing, accessing, and retrieving various kinds of data, including a hierarchical database, a set of files in a file system, an application database in a proprietary format, a relational database management system (RDBMS), etc. Each such database or data store is generally included within a computing device employing a computer operating system such as one of those mentioned above, and are accessed via a network in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the PL/SQL language mentioned above.

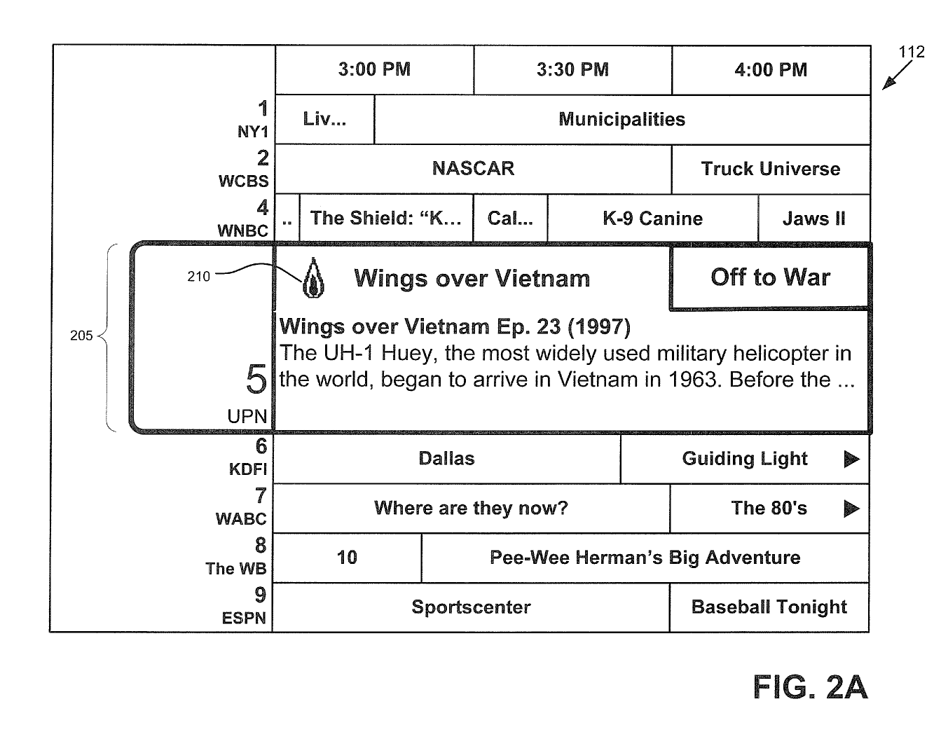

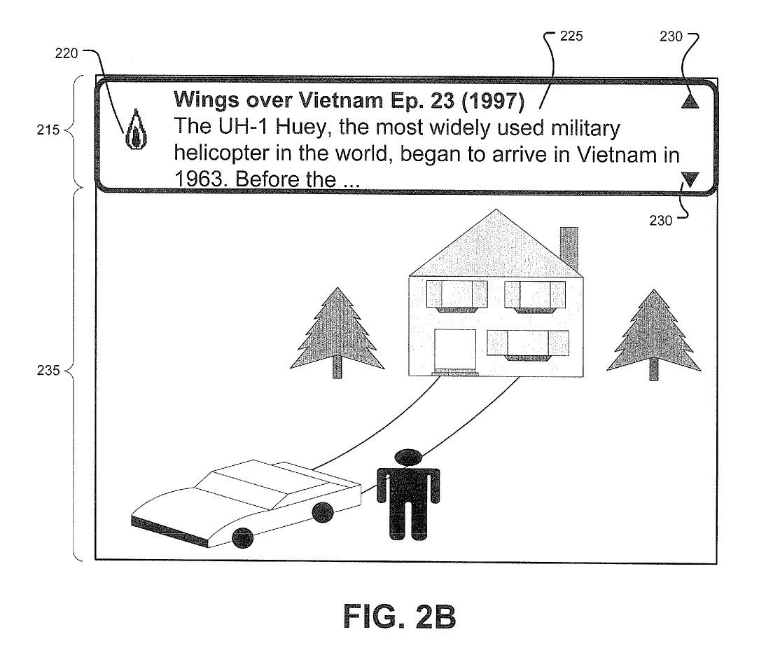

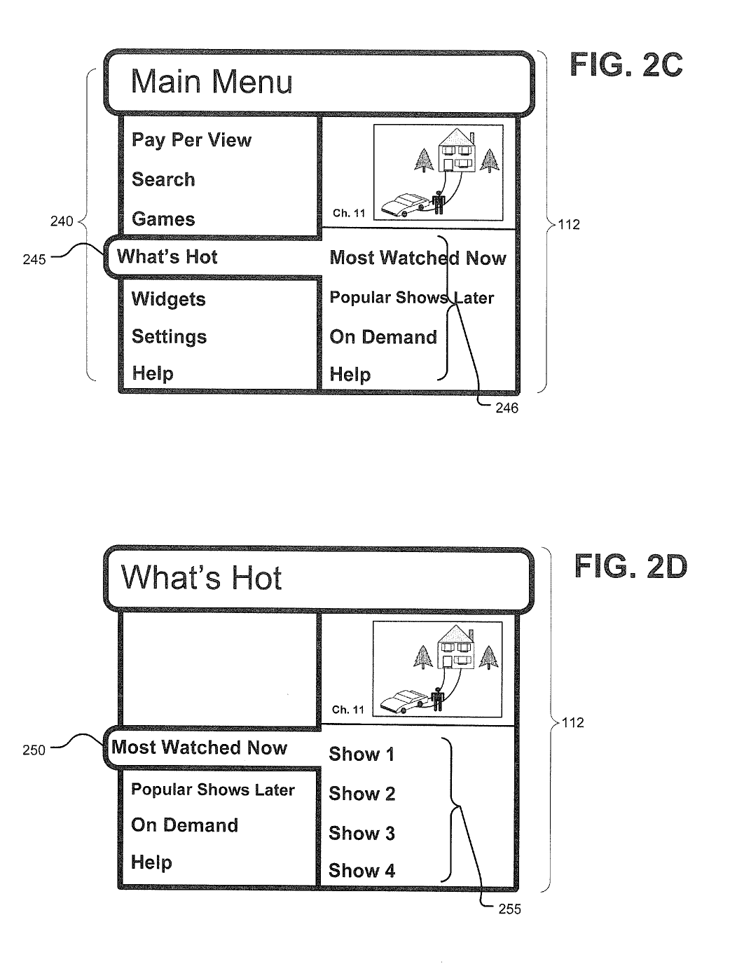

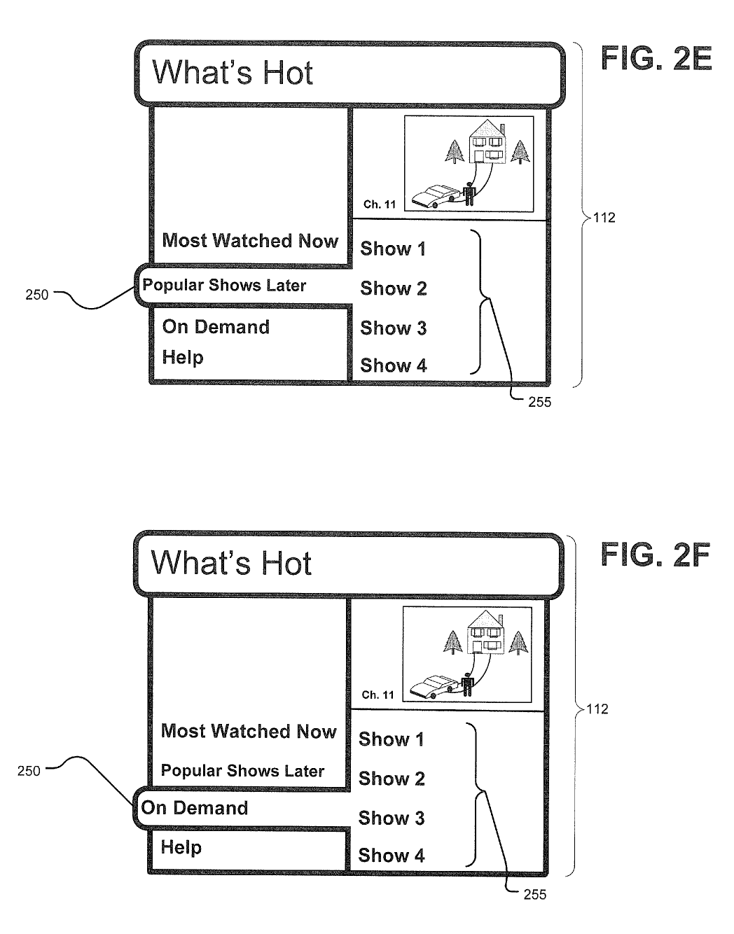

FIG. 2A illustrates an exemplary interface including a popularity indication 210 of ratings data 134 for a media program listing 205 within an IPG GUI 112. Generally, a popularity indication 210 may be included wherever a media program listing 205 may appear in an IPG GUI 112. Popularity indications 210 may include icons, pictures, or other visual elements displayed as part of or adjacent to a media program listing 205. In some implementations, GUI 112 may provide a mechanism for a user to specify icons or the like for popularity indications 210, e.g., a user may choose between images of a star, a flame, and an arrow to be associated with a popularity indication 210.

Popularity indications 210 may be used to indicate that a media program identified by a listing 205 is associated with available ratings data 134. For example, a media program in IPG data 132 identified in ratings data 134 as being popular may be associated with a particular icon used as a popularity indication 210, e.g. a flame, a star, etc. within an IPG GUI 112. A popularity indication 210 may convey additional information as well. Different popularity indications 210 may be associated, for example, with different categories or genres of media programming. For example, different popularity indications 210 may be used based on the demographic for which a program is popular, based on user customization, etc. For instance, a flame icon may be used to indicate that a program is popular with persons under eighteen years of age, while a flower icon may be used to indicate popularity with persons over fifty years of age, etc. Graphical files used for popularity indications 210 may be stored either on the content processing device 110, or may be stored in the IPG database 133 and sent to or requested by the content processing device 110.

FIG. 2B illustrates an exemplary interface including a popularity indication 210 of ratings data 134 appearing within a widget display 215. Widget 105 provides to display 115 a widget display 215, which includes a widget icon 220, widget text 225, and widget navigation arrows 230. Widget icon 220 is used to provide an indication of the kind of information being displayed in widget data interface 215. Widget text 245 is used to provide information to a user of video display 115. In this example, the widget icon 220 may be used to represents the popularity of a media program similar to popularity indication 210 of FIG. 2A, while the widget text 225 includes information about a media program 205 similar to a media program in an IPG GUI 112. Additionally, video signal 150 is displayed as a moving image 235.

FIG. 2C illustrates an exemplary IPG GUI 112 including a main menu. Ratings data 134 may be accessible as a list within IP GUI 112, so that a media consumer may easily identify media programs for which ratings data 134 is available, without scanning the entire IPG GUI 112. The main menu 240 includes a ratings data menu item 245, which when selected may be used to display a list of media programs for which ratings data 134 is available. In this example, ratings data menu item 245 contains several ratings selections 246, including popular media programs on at the current time, popular media programs to be provided in the future, popular on-demand media programs, and a help feature.

Ratings selections 246 represent a filtering of ratings data 134. Filtering is a process of selectively providing ratings data 134 to a user based on one or more filter requirements. A filter requirement may include criteria such as a list of specific media programs, a subject area (e.g. sports, news, comedy, drama, etc.), a parental guide rating, a time, whether the media program is on-demand, whether the media program is a game, etc. A filter requirement may further indicate either to include or exclude selected media programs from the ratings data 134. One or more filter requirements may be stored by the content processing device 110 or by the IPG server 130 in the IPG database 133. A content processing device 110 may include instructions to first determine if any filter requirements are available. If filtering is required, then filtering is performed by identifying at least one media program in a list that has been indicated to be subject to a filtering requirement, determining that the at least one program in the list is included in the ratings data 134, and including or removing the at least one program from the ratings data 134 as indicated by the filter requirement.

For example, as mentioned above, filtering may be performed to account for parental controls. Parental controls include restriction of content intended for adults, such as movies rated as not suitable for young children. In this example, where parental controls prohibit displaying of certain programming, ratings data 134 may be filtered based on a filter requirement including those parental controls. In this way, programming that is prohibited through use of parental controls may also be removed from the ratings data 134.

To take another example, filtering may also be performed to restrict ratings data 134 to include only those media programs accessible to a consumer, e.g., media programs to which a consumer is subscribed. Often, a consumer is subscribed to only a subset of programming available, e.g., via network 145. Certain media programs, e.g. programs provided via subscribed-for channels, can be accessed or viewed by the media consumer, but other remaining media programs cannot be accessed or viewed until the media consumer subscribes to receive them. Because certain media programs cannot be accessed or viewed, ratings data 134 for such inaccessible media programs may be filtered out.

Alternatively, ratings data 134 concerning programming to which a consumer is not subscribed may be purposefully shown. Showing ratings data 134 on popular, but inaccessible, media programs may be used as a mechanism to encourage a consumer to subscribe to additional channels so as to view popular media programs presently unavailable to the consumer. Further, a content processing device 110 may provide an interface to allow a consumer to subscribe to additional channels or services from within an IPG GUI 112.

As yet another example, one or more filter requirements may be selected to place a program guide into a filtered mode. In the filtered mode, filtering may be performed to allow a consumer to view and browse only those media programs specified by the filter requirements, such as media programs in a particular category or genre. The filtered mode may be indicated in the program guide display. Ratings data 134 may also be filtered according to a filtered mode.

FIG. 2D illustrates an exemplary IPG GUI 112 for display of ratings data 134 for media programs available at a current time. Menu selection 250 indicates to a consumer that media programs included in a popular program list 255 are currently available for viewing. The list 255 displays the most popular media programs according to ratings data 134, filtered to display media programs available at the current time. List 255 may be ordered in various ways, for example, in decreasing order of popularity, alphabetical order, order most recently accessed, program age, etc. When a program in the popular media programs list 255 is selected, it may be accessed or viewed. Alternately, a media program may be marked for recording if content processing device 110 is configured to be capable of recording.

FIG. 2E illustrates an exemplary interface for display of ratings data 134 for media programs that will be available in the future, such as later in a given day. Menu selection 250 provides media programs list 255 displaying the most popular media programs based on the ratings data 134, filtered to display media programs available in the future. Choosing one of these media programs from popular media programs list 255 may allow a content processing device 110 to access or view a media program when it becomes available, or alternately record a media program for later if the content processing device 110 is configured to be capable of recording.

FIG. 2F illustrates an exemplary interface for display of ratings data 134 filtered to display on-demand media programs. Menu selection 250 provides popular media programs list 255 displaying the most popular media programs based on the ratings data 134, filtered to display media programs available on-demand. For example, choosing one of these items from popular media programs list 255 may allow a consumer to access or view a selected media program on-demand.

FIG. 3A illustrates an exemplary process 300A for making ratings data 134 available for end user access.

In step 305, a log is requested by an IPG server 130 from each of a plurality of content processing devices 110, either through a VHO, or directly without the use of a VHO. Alternately, logs may be requested by a VHO or by or through another server on the packet switched network 125 or the video distribution network 145. The requested logs generally contain information including which media programs were accessed, viewed, recorded, played, etc., when the action was performed, as well as information on the consumer such as name, age, location, account number, etc. Logs may include information on all media programs accessed or viewed, or may include only a subset of such media programs, such as media programs accessed or viewed for a given period of time, e.g., for at least 5 minutes. Such a constraint prevents “channel surfers” from being included in logs as viewers of media programs.

Logs may include information on media programs accessed or viewed since the last time logs were requested, or logs may contain information on media programs accessed or viewed within a particular time period. Logs may be requested periodically, for example based on a reporting period of once per day, or more or less frequently. Logs may also be requested based on the occurrence or non-occurrence of an event. Content processing device 110 may also send a log without a request, for example based on an internal timer, the occurrence or non-occurrence of an event, such as a powering on of the content processing device 110, etc.

Next, in step 310, the logs collected as described above with reference to step 305 are stored in IPG database 133 by IPG server 130. The logs are stored in a manner to allow for further manipulation once stored, e.g., as a plurality of database records within a RDBMS. For example, each instance of a media program being accessed or viewed may be stored as an individual record within IPG database 133.

Next, in step 315, log records stored in the IPG database 133 are aggregated. As discussed above, because the records in the IPG database 133 include information relating to media programs accessed within a given time period, it is generally desirable to aggregate these records to determine popularity for one or more media programs during the given time period. Aggregated log records are used to generate ratings data 134, described above.

Next, in step 320, ratings data 134 is generated from data aggregated in step 315. Aggregated information is used to create a list of media programs, each program in the list being included in the list according to a number of times the program has previously been accessed. This list is then included in the ratings data 134. Further, ratings data 134 for multiple time periods may be stored in database 133. Data 134 relating to multiple time periods may be used to make determinations relating to trends, such as whether the popularity of a media program increased or decreased from a previous log period. Further, the popularity of a program may be determined over a longer time by aggregating data 134 relating to multiple time periods.

Next, in step 325, ratings data 134 is sent to content processing device 110. The content processing device 110 then may use ratings data 134, along with IPG data 132, to provide an IPG GUI 112, including popularity indications 210, for display on video display 115.

FIG. 3B illustrates an exemplary process 300B for making real time or near real time ratings data 134 available for end user access.

In step 330, real time or near real time data concerning media programming being accessed is provided to an IPG server 130 from at least one, and generally a plurality, of content processing devices 110, either through a VHO, or directly without the use of a VHO. Alternately, such data may be requested by a VHO on a periodic basis, e.g., once per minute, or by or through another server on the packet switched network 125 or the video distribution network 145. The data generally include information such as an identification of media programs that are recently or currently being accessed, viewed, recorded, played, etc., as well as information relating to consumers accessing the media programming, such as name, age, location, account number, etc.

Next, in step 335, the data collected as described above with reference to step 330 is stored in IPG database 133 by IPG server 130. The data, or aggregations of the data such as a number of times a media program has been accessed in a particular time period, are stored in a manner to allow for further manipulation once stored, e.g., as a plurality of database records within an RDBMS. For example, each instance of a media program being accessed or viewed may be stored as an individual record within IPG database 133. However, additionally or alternatively, an aggregate number concerning accesses of particular media programs may be stored as a record within IPG database 133. The data stored in this step may sometimes be referred to as “activity records.”

Next, in step 340, activity records stored in the IPG database 133 are aggregated or, in the case where activity records store data that has already been aggregated, further aggregated. As discussed above, activity records in the IPG database 133 include information relating to media program activity that is collected in real time or near real time. These activity records may then be aggregated to determine an aggregate number of times that each of the one or more media programs are being accessed within any period of time for which activity records relating to a media program of interest have been stored in the database 133.

In other instances, rather than aggregating the activity records for each update of database 133, real time or near real time data may be used to update previously aggregated activity records. For example, real time data may indicate that a content processing device 110 that was viewing or accessing a first media program is now viewing or accessing a second media program. Based on that data, an activity record count for the first program, e.g., a number of times the first program has been viewed, may be decremented and a count for the second program may be incremented. In this manner, activity records may be updated in on a real time or near real time basis.

Next, in step 345, ratings data 134 is generated from data aggregated in step 340, or step 340 may have been skipped, in which case ratings data 134 may be generated from activity records stored as described above with respect to step 335. For example, server 130 may include instructions to create a list of media programs, each program in the list being included in the list according to a number of times the program is being accessed, the list is thus including the ratings data 134.

Next, in step 350, real time or near real time ratings data 134 is sent to content processing device 110. The content processing device 110 then may use ratings data 134, along with IPG data 132, to provide an IPG GUI 112, including popularity indications 210 based on real time or near real time activity, for display on video display 115.

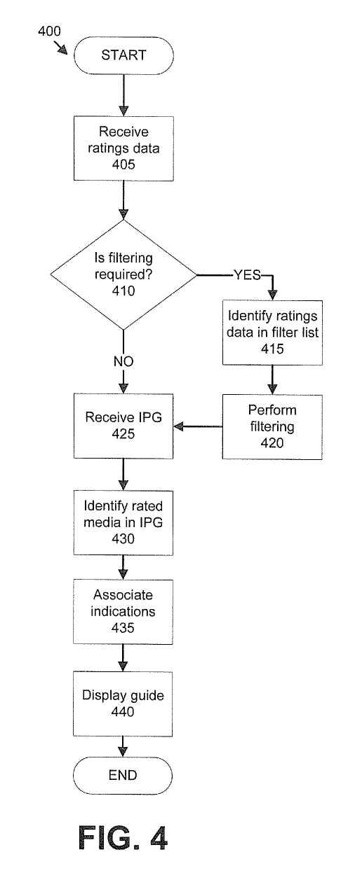

FIG. 4 illustrates an exemplary process 400 for providing and accessing ratings data 134.

In step 405, content processing device 110 receives ratings data 134 from IPG server 130, often via a VHO. The received ratings data 134 may be, for example, aggregated from logs as described above with respect to FIG. 3A, or real time or near real time ratings data 134 aggregated as described above in FIG. 3B.

Next, in step 410, content processing device 110 determines whether filtering of the received ratings data 134 is to be performed. As discussed above, filtering is a process of limiting ratings data 134 based on one or more filter requirements. Filter requirements may be provided by the IPG server 130 and stored in the content processing device 110, may be provided by the content processing device 110 itself, or may be provided by the user or some other source. For example, a user may select via IPG GUI 112 to filter ratings data 134 to display only media programs available at a current time.

If no filter requirement is provided or an empty filter requirement is provided, then no filtering may be necessary. Further, for example parental controls may be inactive or not present, in which case parental control filtering would not be necessary. If filtering is required, then step 415 is executed next. Otherwise, step 425 is executed next.

Next, in step 415, content processing device 110 identifies ratings data 134 that has been indicated to be subject to the filter requirement identified in step 355.

Next, in step 420, content processing device 110 performs the filtering identified in step 355. Alternatively, ratings data 134 may be filtered before being received by content processing device 110. For example, an IPG server 130 may filter IPG data 132 using a filter requirement stored on the IPG server 130, before IPG data 132 is received by a content processing device 110. For instance, a list of certain inaccessible media programs may be used as a filter requirement to exclude media programs known to be inaccessible to a media consumer.

Next, in step 425, content processing device 110 receives IPG data 132 which may be used to create an IPG GUI 112, discussed above. IPG data 132 is received directly or indirectly from an IPG server 130, possibly through a video hub office.

Next, in step 430, content processing device 110 identifies media programs within the IPG data 132 for which ratings data 134 is available. For example, IPG data 132 may include an indicator or flag identifying media programs for which ratings data 134 is available. A content processing device 110 may then be configured to identify one or more flagged or indicated media programs within the received IPG data 132. A media program identified as having ratings data 134 available may appear once or more than once within an IPG GUI 200. For example, a media program may be available from 6:00-7:00 PM, and then again from 8:00-9:00 PM. In this case, both instances of the media program are identified. Other media programs for which ratings data 134 is available may not be listed within the IP GUI 200, and therefore some ratings data 134 may not be associated with any available media programs.

Next, in step 435, content processing device 110 associates popularity indications 210 with media programs in the IPG data 132 identified in the ratings data 134.

Next, in step 440, content processing device 110 makes IPG GUI 200 available for display on video display 115.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A method, comprising:
receiving a first list of media programs, each program in the first list being included in the first list according to a number of times the program has been accessed;
receiving a program guide that includes a second list of media programs;
identifying at least one program in the second list that is included in the first list; and
providing an indication of popularity relating to the at least one program in a user interface that displays some or all of the program guide.

2. The method of claim 1, wherein the second list of programs includes at least one of a broadcast program, a video-on-demand program, a video recording, and a game.

3. The method of claim 1, further comprising performing at least one of:
including an icon for display in the program guide, the icon being representative of the indication;
providing, in the user interface, an option for a user to subscribe to a media channel that provides the at least one program; and
removing the at least one program from the second list according to a filtering requirement.

4. The method of claim 1, further comprising:
receiving a video signal;
providing the video signal to a video display, whereby the video display displays a video image; and
further including in the video display, along with the video image, a description of the at least one program in association with the indication.

5. A method, comprising:
receiving, from a plurality of content processing devices, data relating to a number of times that each of one or more media programs have been accessed from the respective content processing devices within a given time period;
aggregating the data to obtain an aggregate number of times that each of the one or more media programs has been accessed within the given time period;
creating a first list of media programs, each program in the first list being included in the first list according to a number of times the program has previously been accessed; and
providing the first list of media programs to at least one content processing device.

6. The method of claim 5, further comprising providing to the at least one content processing device a program guide that includes a second list of media programs.

7. The method of claim 5, wherein at least some of the data is collected on a real time or near real time basis.

8. The method of claim 5, further comprising:
generating a program guide that includes a second list of media programs;
identifying at least one program in the first list that is included in the second list; and
providing an indication of popularity relating to the at least one program in the program guide.

9. The method of claim 5, further comprising adjusting the aggregate number of times relating to at least one of the media programs according to a number of times that the at least one of the media programs has been available.

10. The method of claim 5, further comprising weighting the aggregate number of times relating to at least one of the media programs according to at least one of the amount of time for which the at least one of the media programs has been available and when the accesses of the at least one of the media programs took place.

11. The method of claim 5, further comprising identifying at least some of the content processing devices according to at least one of a demographic identification, a geographic identification, random selection, and a network address.

12. A content processing device comprising a computer readable medium, the medium having tangibly embodied thereon computer-executable instructions for:
receiving a first list of media programs, each program in the first list being included in the first list according to a number of times the program has been accessed;
receiving a program guide that includes a second list of media programs;
identifying at least one program in the second list that is included in the first list; and
providing an indication of popularity relating to the at least one program in a user interface that displays some or all of the program guide.

13. The device of claim 12, wherein the second list of programs includes at least one of a broadcast program, a video-on-demand program, a video recording, and a game.

14. The device of claim 12, the instructions further including instructions for at least one of:
including an icon for display in the program guide, the icon being representative of the indication;
providing, in the user interface, an option for a user to subscribe to a media channel that provides the at least one program; and
removing the at least one program from the second list according to a filtering requirement.

15. The device of claim 12, the instructions further including instructions for:
receiving a video signal;
providing the video signal to a video display, whereby the video display displays a video image; and
further including in the video display, along with the video image, a description of the at least one program in association with the indication.

16. A server comprising a computer readable medium, the medium having tangibly embodied thereon computer-executable instructions for:
receiving, from a plurality of content processing devices, data relating to a number of times that each of one or more media programs have been accessed within a given time period from the respective content processing devices;
aggregating the data from the content processing devices to obtain an aggregate number of times that each of the one or more media programs has been accessed within the given time period;
creating a first list of media programs, each program in the first list being included in the first list according to a number of times the program has previously been accessed; and
providing the first list of media programs to at least one content processing device.

17. The server of claim 16, the instructions further including instructions for providing to the at least one content processing device a program guide that includes a second list of media programs.

18. The server of claim 16, wherein at least some of the data is collected on a real time or near real time basis.

19. The server of claim 16, the instructions further including instructions for:
generating a program guide that includes a second list of media programs;
identifying at least one program in the first list that is included in the second list; and
providing an indication of popularity relating to the at least one program in the program guide.

20. The server of claim 16, the instructions further including instructions for adjusting the aggregate number of times relating to at least one of the media programs according to a number of times that the at least one of the media programs has been available.

21. The server of claim 16, the instructions further including instructions for weighting the aggregate number of times relating to at least one of the media programs according to at least one of the amount of time for which the at least one of the media programs has been available and when the accesses of the at least one of the media programs took place.

22. The server of claim 16, the instructions further including instructions for identifying at least some of the content processing devices according to at least one of a demographic identification, a geographic identification, random selection, and a network address.

23. A method, comprising:
transmitting, from a plurality of content processing devices to a server, data relating to a number of times that each of one or more media programs have been accessed from the respective content processing devices within a given time period;
aggregating the data to obtain an aggregate number of times that each of the one or more media programs has been accessed within the given time period;
creating a first list of media programs, each program in the first list being included in the first list according to a number of times the program has previously been accessed;
providing the first list of media programs to at least one of the content processing devices;
receiving a program guide that includes a second list of media programs;
identifying at least one program in the second list that is included in the first list; and
providing an indication of popularity relating to the at least one program in a user interface that displays some or all of the program guide.
